(19) United States
(12) Patent Application Publication
(10) Pub. No.: US 2016/0088079 A1
(43) Pub. Date: Mar. 24, 2016

(54) STREAMING PLAYOUT OF MEDIA CONTENT USING INTERLEAVED MEDIA PLAYERS

(71) Applicant: Akhil Mathur, Ashtown (IE)

(72) Inventor: Akhil Mathur, Ashtown (IE)

(73) Assignee: ALCATEL LUCENT, Boulogne-Billancourt (FR)

(21) Appl. No.: 14/492,049

(22) Filed: Sep. 21, 2014

(51) Int. Cl. H04L 29/08

(52) U.S. Cl. CPC H04L 67/1095

(57) ABSTRACT

A capability for supporting streaming playout of media content is presented. The capability for supporting streaming playout of media content may use multiple interleaved media players running in parallel to support interleaved playout of adjacent chunks of a media content item in a round robin manner so as to provide streaming playout of the media content item. The capability for supporting streaming playout of media content enables streaming playout of media content on various types of devices, including resource-constrained devices (e.g., devices constrained in terms of available runtime memory, processing resources, or the like).

### TECHNICAL FIELD

The disclosure relates generally to communication systems and, more specifically but not exclusively, to supporting streaming playout of media content on a resource-constrained device.

### BACKGROUND

In general, the Internet-of-Things (IoT) is a computing concept in which physical objects are connected to the Internet. The physical objects may be IoT devices configured to communicate via the Internet (e.g., sensors, actuators, controllers, or the like) or may be physical objects associated with IoT devices configured to communicate via the Internet. In either case, the IoT devices support communications and may support various other functions (e.g., discovering the existence of other IoT devices, providing information, negotiating service agreements, and the like), typically with little or no human assistance or supervision. The deployment and use of increasing numbers of IoT devices is expected to lead to a wide variety of applications which may significantly improve quality of life. For example, IoT devices may be used to provide retail applications, factory automation applications, healthcare applications, energy generation and distribution applications, agricultural applications, mining applications, and smart-city applications, to name just a few. Additionally, it may be necessary or desirable to use IoT devices to support playout of media content (e.g., in retail settings and other settings). However, the constrained resources of such IoT devices can severely limit the numbers and types of applications which may be supported by the IoT devices, including applications providing playout of media content. Similarly, other types of resource-constrained devices also may be unable to support certain applications, including applications providing playout of media content.

### SUMMARY OF EMBODIMENTS

Various deficiencies in the prior art may be addressed by embodiments for supporting streaming playout of media content.

In at least some embodiments, an apparatus is configured to support playout of a media content item. The apparatus includes a download service module, a set of media players, and a controller. The download service module is configured to download chunks of a media content item from a content source. The set of media players includes a first media player and a second media player. The first media player and the second media player are configured to receive chunks of the media content item and to control playout of received chunks of the media content item via a presentation interface. The controller is configured to control operation of the first media player and the second media player for interleaving playout of adjacent chunks of the media content item between playout by the first media player and playout by the second media player.

In at least some embodiments, a method for supporting playout of a media content item is provided. The method includes performing, by a first media player of a device, playout of a first chunk of a media content item via a presentation interface associated with the device. The method includes performing by a second media player of the device while the first media player is performing playout of the first chunk of the media content item via the presentation interface: requesting a second chunk of the media content item, receiving the second chunk of the media content item, and storing the second chunk of the media content item in a portion of a runtime memory of the device that is allocated for use by the second media player.

In at least some embodiments, a method for supporting playout of a media content item is provided. The method includes downloading chunks of the media content item from a content source. The method includes controlling playout of the chunks of the media content item via a presentation interface using a set of media players comprising a first media player and a second media player, wherein controlling playout of the chunks of the media content item comprises controlling operation of the first media player and the second media player for interleaving playout of adjacent chunks of the media content item between playout by the first media player and playout by the second media player.

### BRIEF DESCRIPTION OF THE DRAWINGS

The teachings herein can be readily understood by considering the following detailed description in conjunction with the accompanying drawings, in which:

FIG. 1 depicts an exemplary communication system including a resource-constrained device configured to support streaming playout of a media content item downloaded to the resource-constrained device via a network;

FIG. 2 depicts an exemplary embodiment of a method for use by a resource-constrained device to support streaming playout of a media content item downloaded to the resource-constrained device via a network; and

FIG. 3 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

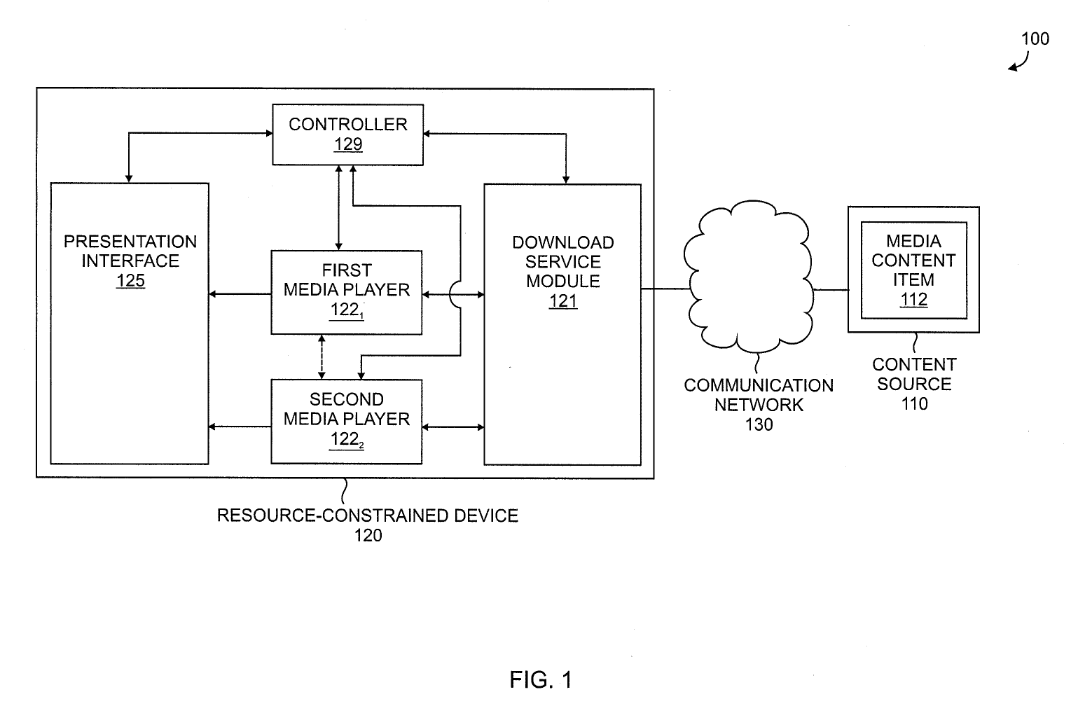

In general, a capability for supporting streaming playout of media content is presented. The capability for supporting streaming playout of media content may use multiple interleaved media players running in parallel to support playout of adjacent chunks of a media content item in a round robin manner so as to provide streaming playout of the media content item. The capability for supporting streaming playout of media content enables streaming playout of media content on various types of devices, including resource-constrained devices (e.g., devices constrained in terms of available runtime memory, processing resources, or the like) and other end devices which may or may not be considered to be resource-constrained. These and various other embodiments and advantages associated with supporting streaming playout of media content may be further understood by considering an exemplary communication system including a device configured to support streaming playout of media content downloaded to the device via a network, as depicted in FIG. 1.

FIG. 1 depicts an exemplary communication system including a resource-constrained device configured to support streaming playout of a media content item downloaded to the resource-constrained device via a network.

As depicted in FIG. 1, the exemplary communication system 100 includes a content source 110 and a resource-constrained device 120. The content source 110 and the resource-constrained device 120 are configured to communicate via a communication network 130.

The content source 110 stores a media content item 112. The content source 110 may be any suitable source of content which may be delivered via communication network 130. For example, content source 110 may be a media server, a cloud storage device, an end user device, or the like. The content source 110 stores or otherwise has access to a media content item 112. The media content item 112 may be an audio content item, a video content item, a multimedia content item including audio and video portions, or the like. For example, the media content item 112 may be an audio advertisement, an audio clip, a song, an album, a video advertisement, an episode of a television program, a portion of a movie, a movie, or the like. The media content item 112 may be stored as a set of chunks or content source 110 may be configured to provide the media content item 112 as a set of chunks responsive to a request for the media content item 112. The chunks of media content item 112 have a defined chunk order according to which the chunks of the media content item are to be played in order to provide playout of the media content item 112. The chunks of media content item 112 may have a defined chunk size, which may be based on length of time (e.g., 1 second chunks, 2 second chunks, or the like), amount of data (e.g., 1 MB chunks, 2 MB chunks, or the like), or the like.

The resource-constrained device 120 is configured to support streaming playout of media content (e.g., media content item 112 available on media source 110). The resource-constrained device 120 may be constrained in terms of runtime memory available for playout of media content, processing resources available for playout of media content, or the like, as well as various combinations thereof.

The resource-constrained device 120 may be an IoT device or any other resource-constrained end device. The resource-constrained device 120 may be used within various environments and contexts. For example, resource-constrained device 120 may be a sensor-based device for use in a smart retail store, such as where the resource-constrained device 120 is deployed within the smart retail store such that, when customers pass in front of the resource-constrained device 120, the resource-constrained device 120 plays a multimedia message downloaded from the cloud (e.g., a store promotion for the smart retail store, an advertisement for a product offered in the smart retail store, or the like). For example, resource-constrained device 120 may be a low-cost personal wearable device (e.g., for health monitoring, lost object tracking, or the like). It will be appreciated that the resource-constrained device 120 may be used within various other environments and contexts.

The resource-constrained device 120 includes a download service module 121, a first media player 122₁ and a second media player 122₂ (collectively, media players 122), a presentation interface 125, and a controller 129.

The download service module 121 is configured to download chunks of media content item 112 from content source 110. The download service module 121 is configured to download chunks of media content item 112 from content source 110 responsive to requests for the chunks from the media players 122, which may be received from the media players 122 directly or from controller 129 (e.g., a media player 122 requests a chunk of media content item 112 by sending a request to controller 129, and controller 129 then sends the request to download service module 121 or otherwise instructs download service module 121 to request a chunk of media content item 112 from content source 110. The download service module 121 may be configured to support downloading of chunks of media content item 112 from content source 110 using any suitable type of chunk download capability (e.g., using File Transfer Protocol (FTP), Hypertext Transfer Protocol (HTTP), or the like). The download service module 121 is configured to make a downloaded chunk of media content item 112 available to the media player 122 that requested the chunk of media content item 112 (e.g., by storing the downloaded chunk of media content item 112 in a memory used by the media player 122, providing the downloaded chunk of media content item 112 to the media player 122 so that the media player 122 may store the downloaded chunk of media content item 112 in a memory used by the media player 122, providing the downloaded chunk of content item 112 to controller 129 so that controller 129 may make the downloaded chunk of media content item 112 available to the media player 122, or the like). The download service module 121 may be configured to provide various other functions in support of streaming playout of the media content item 112 at resource-constrained device 120.

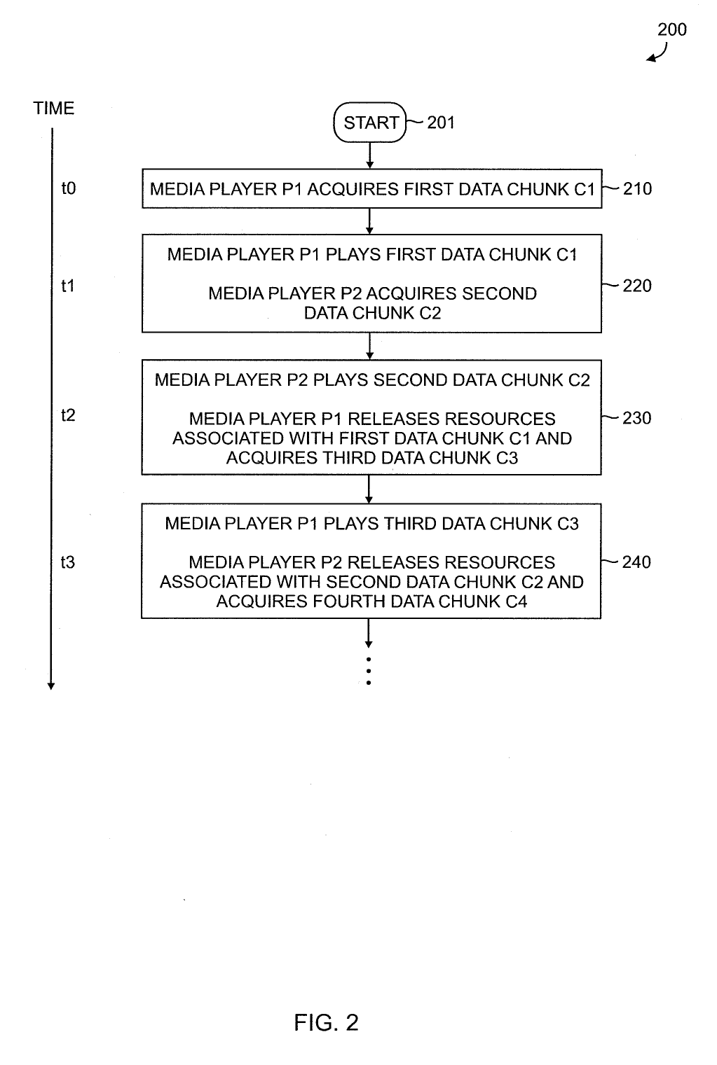

The media players 122 are configured to support streaming playout of media content via presentation interface 122. The media players 122 may be configured to run in parallel to support streaming playout of media content via presentation interface 122. The media players 122 may be configured to run in synchronization with each other in order to support streaming playout of media content via presentation interface 122. The media players 122 may be configured such that, while one media player 122 is playing a chunk of the media content item 112 via presentation interface 125, the other media player 122 is preparing to play a next chunk of the media content item 112 via presentation interface 125 (e.g., requesting delivery of the next chunk of the media content item 112 from content source 110, preparing the next chunk of the media content item 112 for playout via presentation interface 125, or the like). The media players 122 may be configured to interleave or alternate performance of such functions for adjacent chunks of the media content item 112 in a round robin manner so as to support interleaved playout of adjacent chunks of the media content item 112 via presentation interface 125 and, thus, streaming playout of the media content item 112 via presentation interface 125. The parallel nature of acquiring and playing of chunks by the media players 122 results in zero inter-chunk delay or near-zero inter-chunk delay (e.g., typically, inter-chunk delay <5 milliseconds (ms) is not discernible by humans) during streaming playout of the media content item 112 via presentation interface 125. The interleaved operation of media players 122 to support streaming playout of the media content item 112 via presentation interface 125 may be further understood by way of reference to FIG. 2.

The presentation interface 125 is configured to present media content.

The presentation interface 125 is configured to receive media content playout streams from media players 122 and to play the media content transported by the media content playout streams from media players 122. The typical manner in which a presentation interface plays media content of a media content playout stream received from a media player will be understood by one skilled in the art. The configuration of presentation interface 125 may depend on the content type of the media content item 112. For example, where media content item 112 is an audio content item, presentation interface 125 may include one or more speakers configured to output audio of the audio content item. For example, where media content item 112 is a video-only content item, presentation interface 125 may include a display configured to display video of the video-only content item. For example, where media content item 112 is a multimedia content item including audio and video portions, presentation interface 125 may include one or more speakers configured to output audio of the audio portion of the multimedia content item and a display configured to output video of the video portion of the multimedia content item. It will be appreciated that, although primarily presented herein with respect to embodiments in which presentation interface 125 is integrated with resource-constrained device 120, in at least some embodiments all or part of the presentation interface 125 may be external to resource-constrained device 120 (e.g., using a set of speakers communicatively connected to the resource-constrained device 120 for playout of audio content, using one or more display devices communicatively connected to resource-constrained device 120 for playout of video content, or the like, as well as various combinations thereof).

The controller 129, as discussed above, is configured to control various aspects of streaming playout of media content at resource-constrained device 120. For example, controller 129 may be configured to control operation of download service module 121 to download chunks of media content item 112 for streaming playout by media players 122 via presentation interface 125. For example, controller 129 may be configured to control operation of media players 122 to interleave or alternate playout of adjacent chunks of the media content item 112 via the presentation interface 125 and, thus, streaming playout of the media content item 112 via presentation interface 125. The controller 129 may be configured to provide various other control functions in support of streaming playout of media content at resource-constrained device 120. It will be appreciated that, although primarily presented herein as a separate element, various functions presented herein as being performed by controller 129 may be distributed across other elements of the resource-constrained device 120 (e.g., media players 122₁ and 122₂ may interact with download service module 121 directly for requesting and receiving chunks of media content item 112, media players 122₁ and 122₂ may interact with each other directly for determining timing of requests to receive chunks of media content item 112 and playout of received chunks of media content item 112, media players 122₁ and 122₂ may directly control releasing of resources used for processing and playout of chunks of media content item 112, or the like, as well as various combinations thereof).

The resource-constrained device 120 may be configured in various ways to support streaming playout of media content (e.g., media content item 112). In at least some embodiments, for example, resource-constrained device 120 may include one or more microcontrollers. In at least some embodiments, for example, download service module 121 may be a client application running on resource-constrained device 120 (e.g., an FTP client, an HTTP client, or the like). In at least some embodiments, for example, media players 122₁ and 122₂ may be provided using two threads running on a processor, may be provided by two processor cores of a processor, may be provided by two different processors, or the like. In at least some embodiments, for example, media players 122 may be two instances of an available media player of the resource-constrained device 120 (e.g., two instances of a WINDOWS MEDIA PLAYER, two instances of a VLC MEDIA PLAYER, or the like). The media players 122 may share a portion of a runtime memory of resource-constrained device 120 that is dedicated or available for use in supporting streaming playout of media content at the resource-constrained device 120. For example, where only 1 MB of runtime memory is available at resource-constrained device 120 for use in supporting streaming playout of media content at resource-constrained device 120, 500 KB of the runtime memory may be assigned for use by first media player 122₁ and 500 KB of the runtime memory may be assigned for use by the second media player 122₂. For example, where only 2 MB of runtime memory is available at resource-constrained device 120 for use in supporting streaming playout of media content at resource-constrained device 120, 1 MB of the runtime memory may be assigned for use by first media player 122₁ and 1 MB of the runtime memory may be assigned for use by the second media player 122₂. In at least some embodiments, for example, media players 122 may be instantiated within the resource-constrained device 120 under control of an application provided for use in controlling playout of media content (e.g., resource-constrained device 120 internally starts two instances of an available media player of the resource-constrained device 120 and interleaves operation of the two instances of the media player to provide the first and second media players 122 as discussed herein). In at least some embodiments, for example, controller 129 may be provided using a thread running on a processor, using a processor core of a processor, using a processor, or the like. The resource-constrained device 120 may be configured in various other ways to support streaming playout of media content.

The communication network 130 may include any suitable numbers and types of networks and communication elements which may be used to communicatively connect content source 110 and resource-constrained device 120. For example, communication network 130 may include one or more wireless or wireline access network, one or more core networks, or the like, as well as various combinations thereof. The communication network 130 is configured to support downloading of chunks of media content item 112 from content source 110 to resource-constrained device 120.

It will be appreciated that, although primarily depicted and described with respect to specific numbers, types, and arrangements of elements, the exemplary communication system 100 may include various other numbers, types, and arrangements of elements.

FIG. 2 depicts an exemplary embodiment of a method for use by a resource-constrained device to support streaming playout of a media content item downloaded to the resource-constrained device via a network. It will be appreciated that, given the parallel nature by which the two media players of the resource-constrained device operate to support streaming playout of a media content item via the resource-constrained device, method 200 is primarily presented in terms of functions performed by the respective media players within time intervals. As depicted in FIG. 2, time is divided into intervals, and proceeds in a direction from the top of the page toward the bottom of the page.

At step 201, method 200 begins.

At step 210 (associated with a time interval denoted as t0), the first media player (denoted as P1) of the resource-constrained device acquires a first data chunk of the media content item (denoted as C1) from a download service module of the resource-constrained device. The first media player P1 may acquire the first data chunk C1 by initiating a request for the first data chunk C1 (e.g., to the download service module directly, to a controller that is configured to trigger the download service module to download the first data chunk C1, or the like). The first data chunk C1 requested by the first media player P1 is received and stored in a memory used by the first media player P1 to support playout of media content via the presentation interface (e.g., a portion of an available runtime memory of the resource-constrained device that is allocated for use by the first media player P1). It is noted that, during this step, the second media player (denoted as P2) does not perform any functions.

At step 220 (associated with a time interval denoted as t1), the first media player P1 plays the first data chunk C1 via the presentation interface of the resource-constrained device and the second media player P2 acquires the second data chunk of the media content item (denoted as C2). The second media player P2 may acquire the second data chunk C2 by initiating a request for the second data chunk C2 (e.g., to the download service module directly, to a controller that is configured to trigger the download service module to download the second data chunk C2, or the like). The second data chunk C2 requested by the second media player P2 is received and stored in a memory used by the second media player P2 to support playout of media content via the presentation interface (e.g., a portion of an available runtime memory of the resource-constrained device that is allocated for use by the second media player P2). It is noted that the time during which the first media player P1 plays the first data chunk C1 via the presentation interface of the resource-constrained device is expected be adequate for the second media player P2 to acquire the second data chunk C2 (including loading the second data chunk C2 into its memory or its portion of available runtime memory), such that second media player P2 may begin playing the second data chunk C2 via the presentation interface of the resource-constrained device when the first media player P1 finishes playing the first data chunk C1 via the presentation interface of the resource-constrained device (e.g., with little or no inter-chunk delay between playout of adjacent data chunks C1 and C2 of the media content item).

At step 230 (associated with a time interval denoted as t2), the second media player P2, based on a determination that the first media player P1 has finished playing the first data chunk C1 via the presentation interface of the resource-constrained device, begins playing the second data chunk C2 via the presentation interface of the resource-constrained device. The second media player P2 may determine that the first media player P1 has finished playing the first data chunk C1 based on a receipt of a message indicating that the first media player P1 has finished playing the first data chunk C1 (e.g., first media player P1 provides a message to second media player P2 directly, first media player P1 provides a message to a controller of the resource-constrained device which in turn provides the message or a related message to second media player P2, a controller of the resource-constrained device detects that first media player P1 has finished playing the first data chunk C1 and sends a message indicating such to the second media player P2, or the like). The first media player P1, while the second media player P2 plays the second data chunk C2, releases resources associated with playing of the first data chunk C1 and then acquires the third data chunk of the media content item (denoted as C3). The resources associated with playing of the first data chunk C1 may include memory resources used for storing the first data chunk C1 (e.g., a portion of a main memory of a processor where the first media player P1 is running on the processor, a portion of a cache memory of a processor core where the first media player P1 is running on the processor core, or the like). The resources associated with playing of the first data chunk C1 may include other types of resources which may be used by the first media player P1 to play the first data chunk C1. The first media player P1 may release the resources associated with playing of the first data chunk C1 by discarding the first data chunk C1 from the portion of the runtime memory of the resource-constrained device that is allocated for use by the first media player P1, requesting that a garbage collector module of the resource-constrained device release the resources associated with playing of the first data chunk C1, requesting that a controller of the resource-constrained device instruct a garbage collector module of the resource-constrained device to release the resources associated with playing of the first data chunk C1, or the like). It is noted that the time during which the second media player P2 plays the second data chunk C2 via the presentation interface of the resource-constrained device is expected be adequate for the first media player P1 to acquire the third data chunk C3 (including loading the third data chunk C3 into its memory or its portion of available runtime memory), such that first media player P1 may begin playing the third data chunk C3 via the presentation interface of the resource-constrained device when the second media player P2 finishes playing the second data chunk C2 via the presentation interface of the resource-constrained device (e.g., with little or no inter-chunk delay between playout of adjacent data chunks C2 and C3 of the media content item).

At step 240 (associated with a time interval denoted as t3), the first media player P1, based on a determination that the second media player P2 has finished playing the second data chunk C2 via the presentation interface of the resource-constrained device, begins playing the third data chunk C3 via the presentation interface of the resource-constrained device. The first media player P1 may determine that the second media player P2 has finished playing the second data chunk C2 based on a receipt of a message indicating that the second media player P2 has finished playing the second data chunk C2 (e.g., second media player P2 provides a message to first media player P1 directly, second media player P2 provides a message to a controller of the resource-constrained device which in turn provides the message or a related message to first media player P1, a controller of the resource-constrained device detects that second media player P2 has finished playing the second data chunk C2 and sends a message indicating such to the first media player P1, or the like). The second media player P2, while the first media player P1 plays the third data chunk C3, releases resources associated with playing of the second data chunk C2 and acquires the fourth data chunk of the media content item (denoted as C4). The resources associated with playing of the second data chunk C2 may include memory resources used for storing the second data chunk C2 (e.g., a portion of a main memory of a processor where the second media player P2 is running on the processor, a portion of a cache memory of a processor core where the second media player P2 is running on the processor core, or the like). The resources associated with playing of the second data chunk C2 may include other types of resources which may be used by the second media player P2 to play the second data chunk C2. The second media player P2 may release the resources associated with playing of the second data chunk C2 by discarding the second data chunk C2 from the portion of the runtime memory of the resource-constrained device that is allocated for use by the second media player P2, requesting that a garbage collector module of the resource-constrained device release the resources associated with playing of the second data chunk C2, requesting that a controller of the resource-constrained device instruct a garbage collector module of the resource-constrained device to release the resources associated with playing of the second data chunk C2, or the like). It is noted that the time during which the first media player P1 plays the third data chunk C3 via the presentation interface of the resource-constrained device is expected be adequate for the second media player P2 to acquire the fourth data chunk C4 (including loading the fourth data chunk C4 into its memory or its portion of available runtime memory), such that second media player P2 may begin playing the fourth data chunk C4 via the presentation interface of the resource-constrained device when the first media player P1 finishes playing the third data chunk C3 via the presentation interface of the resource-constrained device (e.g., with little or no inter-chunk delay between playout of adjacent data chunks C3 and C4 of the media content item).

It will be appreciated that method 200 is not depicted and described as ending, as method 200 is expected to continue to operate in this manner (e.g., alternating use of first media player P1 and second media player P2 to play and acquire adjacent data chunks of the media content item so as to enable streaming playout of the media content items) until the entire media content item has been played at the resource-constrained device. The method 200 may end after all of the chunks of the media content item have been played via the presentation interface and resources associated with playing of the media content item have been released, after all of the chunks of the media content item have been played via the presentation interface and the media players have been terminated, or the like, as well as various combinations thereof. It will be appreciated that the media players may remain instantiated at the resource-constrained device, or may be terminated and then re-instantiated when a next media content item is to be played at the resource-constrained device.

Various embodiments of the capability for supporting streaming playout of media content on a resource-constrained device may provide various advantages, at least some of which have been discussed or otherwise indicated above. In at least some embodiments, the capability for supporting streaming playout of media content on a resource-constrained device may solve the problem of supporting playout of media content on a resource-constrained device even where the resource-constrained device has as little as 1 MB (or perhaps even less) of runtime memory available for use in streaming playout of media content. In at least some embodiments, the capability for supporting streaming playout of media content on a resource-constrained device may solve the problem of supporting playout of media content on a resource-constrained device without hampering user experience (e.g., without jitter or delay that would otherwise be experienced by users in the absence of the capability for supporting streaming playout of media content on a resource-constrained device). In at least some embodiments, the capability for supporting streaming playout of media content on a resource-constrained device may enable reduction of the average inter-chunk delay (e.g., as compared with systems in which a single player must acquire a next data chunk, after playing a current data chunk, before beginning to play the next data chunk) by a relatively large factor. For example, it was determined that, for an audio file encoded at 128 kbps and having a fixed chunk size of 128 kB, embodiments of the capability for supporting streaming playout of media content on a resource-constrained device resulted in inter-chunk delays of approximately 5 ms (as compared with use of a single media player, in which the inter-chunk delays were approximately 600 ms), which was not discernible by humans and, therefore, resulted in a seamless streaming experience). Similarly, for example, it was determined that, for an audio file encoded at 128 kbps and having a fixed chunk size of 32 kB, embodiments of the capability for supporting streaming playout of media content on a resource-constrained device resulted in inter-chunk delays of approximately 3 ms (as compared with use of a single media player, in which the inter-chunk delays were approximately 250 ms), which, again, was not discernible by humans and, therefore, resulted in a seamless streaming experience). Accordingly, it has been determined that, for at least some embodiments of the capability for supporting streaming playout of media content on a resource-constrained device, chunk size has no practical effect on the perceived performance. Various embodiments of the capability for supporting streaming playout of media content on a resource-constrained device may provide various other advantages.

It will be appreciated that, although primarily presented herein with respect to a resource-constrained device that uses two media players to support streaming playout of media content, in at least some embodiments a resource-constrained device may use more than two players to support streaming playout of media content. In at least some such embodiments, the three or more media players of the resource-constrained device may operate in a round robin manner for supporting streaming playout of a media content item at the resource-constrained device. In at least some embodiments, a controller of the resource-constrained device may control the three or more media players of the resource-constrained device such that the three or more media players may be used in any order for supporting streaming playout of a media content item at the resource-constrained device.

It will be appreciated that, although primarily presented herein with respect to use of multiple media players to support streaming playout of media content at a resource-constrained device, use of multiple media players to support streaming playout of media content may be provided for various other types of end devices including end device that are not resource-constrained or not considered to be resource constrained given the amount of resources necessary to support required or desired end user quality of experience during playout of media content.

It will be appreciated that, although primarily presented herein with respect to use of a set of media players of a device to support streaming playout of media content, in at least some embodiments the download service module and the set of media players used to support streaming playout of media content may be provided on multiple devices. For example, the download service module may be provided on a first end device (e.g., IoT device, other resource-constrained device, other end device, or the like), a first media player may be provided on second end device (e.g., IoT device, other resource-constrained device, other end device, or the like), a second media player may be provided on third end device (e.g., IoT device, other resource-constrained device, other end device, or the like), and the three end device may cooperate to support streaming playout of media content via a presentation interface that is associated at least with the second and third devices supporting the first and second media players.

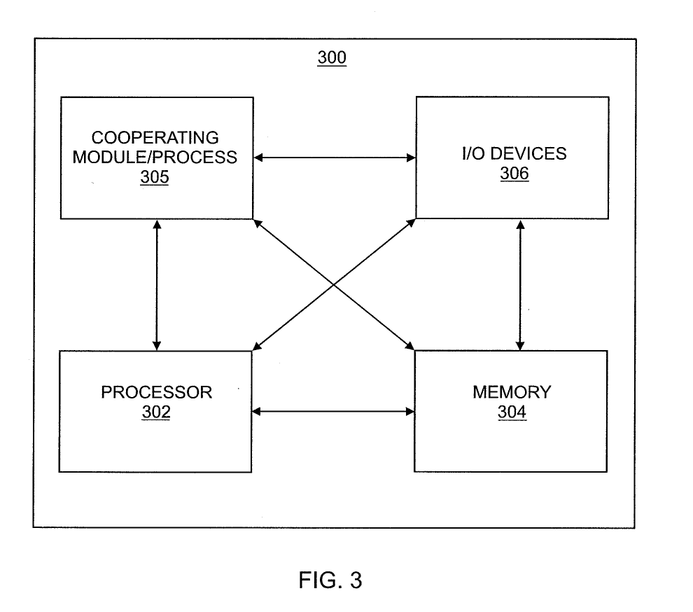

FIG. 3 depicts a high-level block diagram of a computer suitable for use in performing functions described herein.

The computer 300 includes a processor 302 (e.g., a central processing unit (CPU) and/or other suitable processor(s)) and a memory 304 (e.g., random access memory (RAM), read only memory (ROM), and the like).

The computer 300 also may include a cooperating module/process 305. The cooperating process 305 can be loaded into memory 304 and executed by the processor 302 to implement functions as discussed herein and, thus, cooperating process 305 (including associated data structures) can be stored on a computer readable storage medium, e.g., RAM memory, magnetic or optical drive or diskette, and the like.

The computer 300 also may include one or more input/output devices 306 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 300 depicted in FIG. 3 provides a general architecture and functionality suitable for implementing functional elements described herein and/or portions of functional elements described herein. For example, the computer 300 provides a general architecture and functionality suitable for implementing one or more of content source 110, resource-constrained device 120, an element of communication network 130, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that at least some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media (e.g., non-transitory computer-readable storage media), transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a download service module configured to download chunks of a media content item from a content source;
a set of media players comprising a first media player and a second media player, the first media player and the second media player each configured to receive chunks of the media content item and to control playout of received chunks of the media content item via a presentation interface; and
a controller configured to control operation of the first media player and the second media player for interleaving playout of adjacent chunks of the media content item between playout by the first media player and playout by the second media player.

2. The apparatus of claim 1, wherein the first media player is configured to play a first chunk of the media content item via the presentation interface and the second media player is configured to obtain a second chunk of the media content item while the first media player plays the first chunk of the media content item.

3. The apparatus of claim 2, wherein the second media player is configured to play the second chunk of the media content item via the presentation interface, wherein the first media player is configured to release resources associated with playing the first chunk of the media content item and obtain a third chunk of the media content item while the second media player plays the second chunk of the media content item.

4. The apparatus of claim 1, wherein the first media player is configured to:
request a first chunk of the media content item;
receive the first chunk of the media content item; and
store the first chunk of the media content item in a portion of a runtime memory allocated for use by the first media player.

5. The apparatus of claim 4, wherein to request the first chunk of the media content item, the first media player is configured to:
initiate a request for the first chunk of the media content item to the controller or to the download service module.

6. The apparatus of claim 4, wherein the first media player is configured to:
play the first chunk of the media content item for presentation via the presentation interface.

7. The apparatus of claim 6, wherein the second media player is configured to:
while the first media player is playing the first chunk of the media content item:
request a second chunk of the media content item;
receive the second chunk of the media content item; and
store the second chunk of the media content item in a portion of the runtime memory allocated for use by the second media player.

8. The apparatus of claim 6, wherein the second media player is configured to:
after the first media player has finished playing the first chunk of the media content item:
play the second chunk of the media content item for presentation via the presentation interface.

9. The apparatus of claim 8, wherein the first media player is configured to:
while the second media player is playing the second chunk of the media content item:
initiate release of resources associated with playout of the first chunk of the media content by the first media player;
request a third chunk of the media content item;
receive the third chunk of the media content item; and
store the third chunk of the media content item in the portion of the runtime memory allocated for use by the first media player.

10. The apparatus of claim 1, wherein the download service module is configured to download chunks of the media content item from the content source based on a File Transfer Protocol (FTP) or a Hypertext Transfer Protocol (HTTP).

11. The apparatus of claim 1, wherein the controller is configured to instantiate the first media player and the second media player based on an instruction received from a network server.

12. A method, comprising:
performing, by a first media player of a device, playout of a first chunk of a media content item via a presentation interface associated with the device; and
performing by a second media player of the device while the first media player is performing playout of the first chunk of the media content item via the presentation interface:
requesting a second chunk of the media content item;
receiving the second chunk of the media content item; and
storing the second chunk of the media content item in a portion of a runtime memory of the device that is allocated for use by the second media player.

13. The method of claim 12, wherein the second media player requests the second chunk of the media content item by initiating a request for the second chunk of the media content item to a controller of the device, the controller configured to control operation of the first media player and the second media player for interleaving playout of adjacent chunks of the media content item between playout by the first media player and playout by the second media player.

14. The method of claim 12, wherein the second media player requests the second chunk of the media content item by initiating a request for the second chunk of the media content item to a download service module of the device, the download service module configured to download chunks of the media content item from a content source via a network.

15. The method of claim 14, wherein the download service module is configured to download chunks of the media content item from the content source based on a File Transfer Protocol (FTP) or a Hypertext Transfer Protocol (HTTP).

16. The method of claim 12, further comprising:
performing by the second media player after the first media player has finished playing the first chunk of the media content item:
playing the second chunk of the media content item for presentation via the presentation interface.

17. The method of claim 16, further comprising:
performing by the first media player while the second media player is playing the second chunk of the media content item:
initiating release of resources associated with playout of the first chunk of the media content by the first media player;
requesting a third chunk of the media content item;
receiving the third chunk of the media content item; and
storing the third chunk of the media content item in the portion of the runtime memory allocated for use by the first media player.

18. The method of claim 17, wherein the first media player requests the third chunk of the media content item by initiating a request for the third chunk of the media content item to a controller of the device or to a download service module of the device.

19. The method of claim 12, further comprising:
instantiating the first media player and the second media player based on an instruction received from a network server.

20. A method, comprising:
downloading chunks of a media content item from a content source; and
controlling playout of the chunks of the media content item via a presentation interface using a set of media players comprising a first media player and a second media player, wherein controlling playout of the chunks of the media content item comprises controlling operation of the first media player and the second media player for interleaving playout of adjacent chunks of the media content item between playout by the first media player and playout by the second media player.
